(19) United States
(12) Patent Application Publication
(10) Pub. No.: US 2024/0149227 A1
(43) Pub. Date: May 9, 2024

(54) METHOD FOR PRODUCING A HOMOGENEOUS MIXTURE AND THE HOMOGENEOUS MIXTURE USING THE SAME

(71) Applicant: Pio KIM, Fullerton, CA (US)

(72) Inventor: Pio KIM, Fullerton, CA (US)

(21) Appl. No.: 17/983,799

(22) Filed: Nov. 9, 2022

(51) Int. Cl. B01F 23/411; B01F 23/41; B01F 31/80

(52) U.S. Cl. CPC B01F 23/4111; B01F 23/4105; B01F 23/4141; B01F 23/4145; B01F 31/89

(57) ABSTRACT

Provided is a method for producing a homogeneous mixture and the homogeneous mixture using the same. A method for producing a homogeneous mixture comprises stirring two liquid components being immiscible each other; mixing and homogenizing the two liquid components as a first homogenizing stage in a high pressure; applying an ultrasonic wave to the first homogenized two components as a first ultrasonic stage; regulating a weight ratio of the homogeneous components; homogenizing the regulated homogeneous components as a second homogenizing stage in a high pressure; applying an ultrasonic wave to the second homogenized components as a second ultrasonic stage; and generating a homogeneous mixture without any layer separation.

### BACKGROUND OF THE INVENTION

### 1. Field of the Invention

The present invention relates to a method for producing a homogeneous mixture and the homogeneous mixture using the same, in particular for producing a homogeneous mixture of a water and an oil and the homogeneous mixture of the water and the oil using the same.

### 2. Description of the Related Art

An emulsifier or a surfactant has to be used for mixing a water and an oil uniformly without any layer separation. The emulsifier is a compound with a hydrophilic group and a lipophilic group, and may have a function of emulsifying a hydrophilic compound and a lipophilic compound. A bonding of two immiscible compound by such the emulsifier has not characteristic of a uniform or a homogeneous mixture. And also, the emulsifier itself may be a compound to be harmful to a human body. And also, when the emulsifier is used for mixing the water and the oil, a separation between a water layer and an oil layer over time. Therefore, a method for mixing the water and the oil homogeneously without using the emulsifier need to be developed. With respect to a homogeneous mixture of the water and the oil, Korean patent publication No. 10-2002-0032293 discloses a device for homogenizing an oil and a water. And also, Korean publication No. 10-2012-0072760 discloses a device for mixing a water and an oil homogeneously. But the prior art doesn't disclose a technic to mix the water and the oil uniformly and to maintain for a long time. Although the homogeneous mixture of the water and the oil to be maintained for a long time may be useful in a cosmetic industry, a medical industry or the like, the prior or a known technic doesn't disclose such a skill.

The present invention has the following purpose for solve the problem

### PURPOSE OF THE INVENTION

An object of the present invention is to provide with a method for producing a homogeneous mixture and the homogeneous mixture using the same, wherein the mixture may be maintained for a long time without any layer separation.

### SUMMARY OF THE INVENTION

In one embodiment of the present invention, a method for producing a homogeneous mixture comprises stirring two liquid components being immiscible each other; mixing and homogenizing the two liquid components as a first homogenizing stage in a high pressure; applying an ultrasonic wave to the first homogenized two components as a first ultrasonic stage; regulating a weight ratio of the homogeneous components; homogenizing the regulated homogeneous components as a second homogenizing stage in a high pressure; applying an ultrasonic wave to the second homogenized components as a second ultrasonic stage; and generating a homogeneous mixture without any layer separation.

In other embodiment of the present invention, the two components are a water and an oil.

In another embodiment of the present invention, the water and the oil are mixed in a weight ratio of water:oil=80:10 to 30 in the first homogenizing stage, and in a weight ration of water:oil=100:0.1 to 10 in the regulating stage.

In still another embodiment of the present invention, 10,000 to 30,000 psi pressure is applied in the first or second homogenizing stage.

In still another embodiment of the present invention, the ultrasonic wave frequency is 20 kHz to 30 kHz frequency in the first or the second ultrasonic stage.

In still another embodiment of the present invention, a homogeneous mixture of a water and an oil is provided, wherein the weight ratio of the water and the oil is water:oil=100:0.1 to 5 and the mixture has no layer separation.

### BRIEF DESCRIPTION OF THE DRAWINGS

FIG. 1 shows an exemplary embodiment of a method for producing a homogeneous mixture according to the present invention.

FIG. 2 shows an exemplary embodiment of a homogenizer for the method according to the present invention.

FIG. 3 and FIG. 4 show a homogenizing module for a homogenizing process according to the present invention.

FIG. 5 shows an exemplary embodiment of a heat exchanger for the method according to the present invention.

FIG. 6 shows an exemplary embodiment of an ultrasonic unit for the method according to the present invention.

FIG. 7A to FIG. 7F show EDS test results to the mixture of the water and the oil according to the present invention.

FIG. 8A and FIG. 8H show FTIR test results to the mixture of the water and the oil according to the present invention.

### DETAILED DESCRIPTION OF EXEMPLARY EMBODIMENTS

Exemplary embodiments of the present invention will be described herein below with reference to the accompanying drawings.

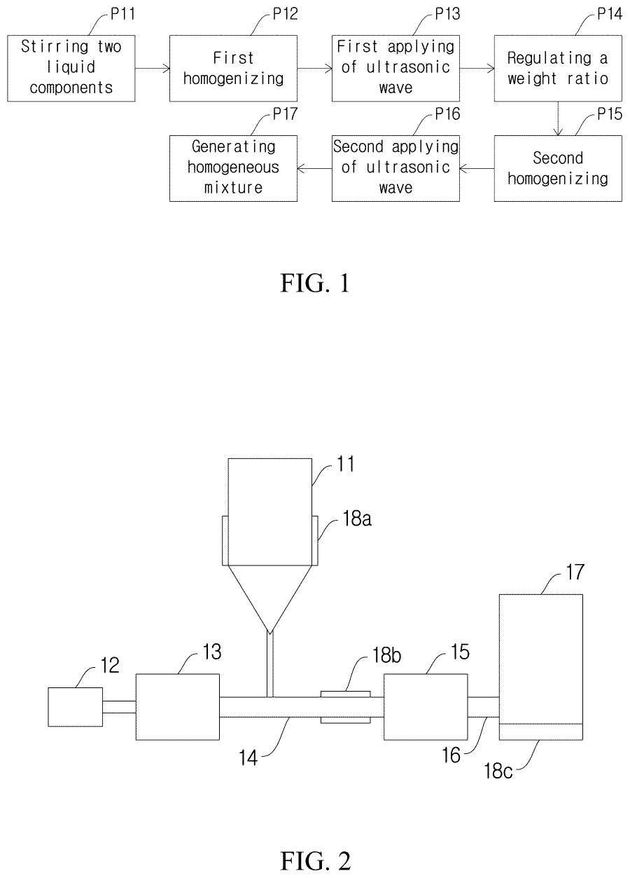

FIG. 1 shows an exemplary embodiment of a method for producing a homogeneous mixture according to the present invention.

Referring FIG. 1 a method for producing a homogeneous mixture comprises stirring two liquid components being immiscible each other P11; mixing and homogenizing the two liquid components as a first homogenizing stage in a high pressure P12; applying an ultrasonic wave to the first homogenized two components as a first ultrasonic stage P13; regulating a weight ratio of the homogeneous components P14; homogenizing the regulated homogeneous components as a second homogenizing stage in a high pressure P15; applying an ultrasonic wave to the second homogenized components as a second ultrasonic stage P16; and generating a homogeneous mixture without any layer separation P17.

Two immiscible components may be prepared, and two components may be, for example, a water and an oil. The oil component may be a lavender oil, an orange oil, a phytoncide, a pine tree oil or the like, and such oil component may be extracted from a natural plant, not limited to. The two components may be separated forming each layer if a component such as an emulsifier is not added. When the two components are prepared, a stirring process may be performed. The two components may be mixed in a weight ratio of water:oil=80:10 to 30, preferably 80:15 to 25, most preferably 80:20 and may be stirred P11. A device for stirring may be prepared, and the two components such as the water and the oil may be stirred in the device P11, and then a high pressure homogenizing process may be advanced. The high pressure homogenizing process may be performed in a high pressurizing apparatus such as a homogenizer, and 10,000 to 30,000 psi pressure may be applied to the two components in the homogenizer for advancing the high pressure process. The two components may be made of a first homogenized solution through an impact, a mixing process, a shearing force, a cavitation process during the homogenizing process P12. The first homogenized solution may be transferred to a heat exchanger for cooling, and the solution may be treated with an ultrasonic wave as a first ultrasonic wave stage 13. Specifically, an ultrasonic wave may be applied to the solution when the solution passes the heat exchanger. The first ultrasonic wave treatment may be performed in a condition of 10 to 25° C. temperature by an ultrasonic transducer with an output of 500 to 2,500 Watt, and a frequency of the applied ultrasonic wave may be 20 kHz to 30 kHz. When the first sonication is complete as such condition P13, the first mixed solution or the first homogenized solution may be made. The first homogenized solution may be diluted for regulating the component ratio of the water and the oil P14, and the weight ratio of the water and the oil may be made as water:oil=100:0.1 to 10 by regulating the component ratio. When the component ration is adjusted in this way, a second homogenizing process may be advanced P14. The second homogenizing process may be performed as the same as or similar to the first homogenizing process. Specifically, 10,000 to 30,000 psi pressure may be applied to the adjusted solution for the second homogenizing process. A second homogenizing solution may be made by the second homogenizing process, and the second solution may be transferred to the heat exchanger. And then, a second sonication process may be performed to the second solution as the same as or similar to the first sonication P16. Thus a homogeneous mixture being immiscible each other may be generated through such second sonication. The homogenous mixture made in this way may be maintained as mixed uniformly without any layer separation even though storing for a long time. The mixture components may be the water and the oil, not limited to. The first and second homogenizing process may be performed in the homogenizer, and an exemplary embodiment of the homogenizer will be disclosed below.

FIG. 2 shows an exemplary embodiment of the homogenizer for the method according to the present invention.

Referring to FIG. 2, a homogenizer comprises an inputting container 11 for inputting a raw material solution; a pressing module 13 for applying a pressure to the input raw material solution; a homogenizing module 15 for making the raw material solution as a homogenous solution using a pressure applied by the pressing module 13; a heat exchanger 17 for stabilizing and discharging the homogeneous solution; and an ultrasonic wave unit 18a, 18b, 18c for applying an ultrasonic wave to the raw material solution or the homogeneous solution.

When the raw material solution stored in the inputting container is guided to the transferring passage 14, a driving unit 12 such as a pump or a motor may actuate the pressing module 13 such as a plunger capable of moving in a round trip. The raw material solution may become a material made to be homogeneous state by the homogenizer, and the raw material solution may comprise at least one solvent and at least one solute. The raw material solution may become various solutions such as a food industry containing a cooking oil, a powdered milk, a margarine or a mayonnaise, or a chemical industry containing an ink, a soap, a fuel oil, a vitamin, a toothpaste, a paint or a perfume. And also, the raw material solution may comprise a medical product, a dying product, a silicone product, a resin product and the like, not limited to. The raw material solution may be transferred along the transferring pipe 14 under being pressed to be input into the homogeneous module 15. The homogeneous module 15 may have a function to collide the raw material solution for making the homogenous solution by crushing be a nanometer size and mixing the crushed material. The homogeneous solution formed by the homogeneous module 15 may be guided to the heat exchanger 17 via a guiding pipe 16, and then the homogeneous solution may be discharged outside after stabilizing.

According to one embodiment of the present invention, the ultrasonic wave may be applied to the raw material solution or the homogeneous solution. Specifically, the ultrasonic wave may be applied to the raw material solution by the ultrasonic wave unit 18a installed at an inner part or outer part of the inputting container 11. The ultrasonic wave may be applied to the flowing raw material by the ultrasonic wave unit 18b installed at the transferring pipe 14. And also, the ultrasonic wave unit 18c may be installed at the heat exchanger 17. For example, the ultrasonic wave unit 18c may be installed at a lower part of the heat exchanger 17 for applying the ultrasonic wave to the homogeneous solution flowing within the heat exchanger 17. A homogeneity and a stability of the homogeneous solution can be enhanced by applying the ultrasonic wave. The ultrasonic wave unit 18a, 18b, 18c may be installed at various places to apply the ultrasonic wave to the raw material solution or the homogeneous solution. The ultrasonic wave unit 18a, 18b, 18c may apply the ultrasonic wave with various frequencies, for example, 20 kHz to 10 MHz frequency. An ultrasonic of various frequencies may be applied to the raw material solution or the homogeneous solution, not limited to.

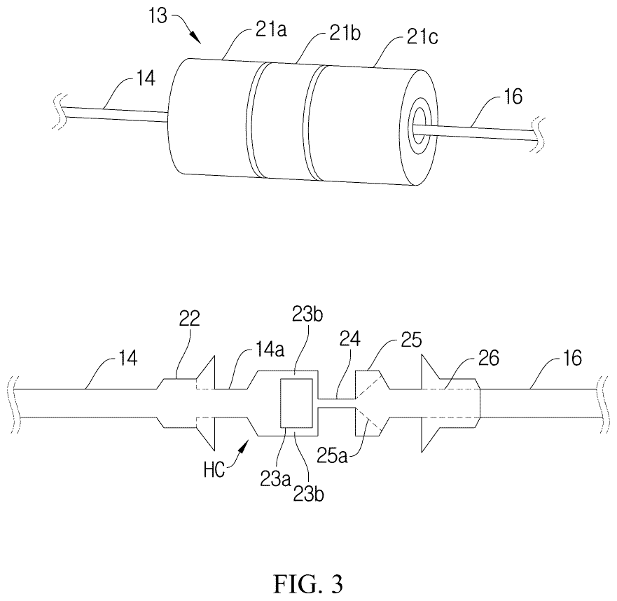

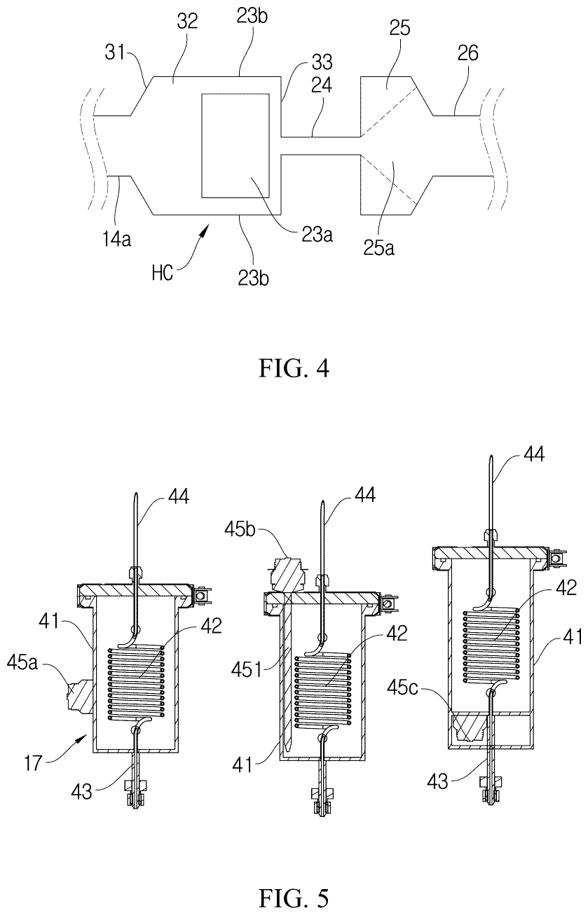

FIG. 3 and FIG. 4 show a homogenizing module for a homogenizing process according to the present invention.

Referring to FIG. 3, the raw material solution transferred along the transferring pipe 14 may be input into the homogeneous module 15, and the homogeneous module 15 may comprise three protecting blocks 21a, 21b, 21c. Each protecting block 21a, 21b, 21c may have a cylindrical shape or a drum shape, and the protecting blocks 21a, 21b, 21c may be connected to each other. The length of the first and the third protecting block 21a, 21c may be longer than that of the second block 21b. The protecting blocks 21a, 21b, 21c may be made of a material with a big specific gravity such as a metal, and the protecting blocks 21a, 21b, 21c may have a structure that an outer vibration or impact can't be delivered to a homogeneous means arranged inside. An inner guiding passage formed within the homogeneous module 15 may be connected to the transferring pipe 14, and a staying volume 22 may be formed at the inner guiding passage. An inner diameter of the staying volume 22 may be bigger than that of the inner guiding passage, and the staying volume 22 may be connected to an inner transferring passage 14a. And the diameter of the inner transferring passage 14a may be similar or equal to that of the transferring pipe 14. A homogeneous cell HC may be connected to the inner transferring passage 14a. The homogeneous cell HC may comprise a homogeneous passage having a bigger diameter relative to that of the inner transferring passage 14a and an impact guiding block 23a arranged within the homogeneous passage. The raw material solution input into the homogeneous cell HC from the inner transferring passage 14a may be introduced to an entering volume having a bigger diameter relatively to be impacted on the impact guiding block 23a. And then the solution may flow in a horizontal direction along a gap passage 23b formed between the impact guiding block 23a and the homogeneous cell HC. And then, the solution may flow along a cavitation passage 24 having a smaller diameter relative to that of the inner transferring passage 14a at an end part of the impact guiding block 23a, And the raw material solution may be guided to a diffusing block 25 with a diffusing passage 25a. The diffusing passage 25a may have a trumpet shape or a cone shape, and the raw material solution guided along the diffusing passage 25a may flow a homogeneous discharging passage 26 connected to the guiding passage 16. As mentioned above, the homogeneous solution may be generated through an impacting, a mixing, a sheer force and a cavitation process within the homogeneous cell HC. The structure of the homogeneous cell HC will be explained below.

Referring to FIG. 4, the homogeneous cell HC connected to the inner transferring passage 14a may comprise a tilted guiding part 31 and a route forming volume 32, wherein a section size of the tilted guiding part 31 becomes larger gradually in an extending direction, and the route forming volume 32 may extend from the tilted guiding part 31 with a cylindrical shape and with a constant diameter. And an impact guiding block 23a may be arranged within an inner portion of the route forming volume 32. The impact guiding block 23a may become a cylindrical shape and the diameter and the length of the impact guiding block 23a may be smaller than those of the route forming volume 32. For example, the diameter of the impact guiding block 23a may become ½ to 9/10 to the impact guiding block 23a diameter. And the length of the impact guiding block may become ⅖ to ¾ to the route forming volume 32 length. A vertical guiding passage 33 may be formed apart from the rear surface of the route forming volume 32, and the section size of the vertical guiding passage 33 may be smaller than that of the gap passage 23b. The raw material solution may flow in a horizontal direction along the gap passage 23b, and then flow in a vertical direction along the vertical guiding passage 33. The cavitation passage 24 may be connected to a center portion of the route forming volume 32, the section size of the cavitation passage 24 may be ⅕ to ½ to the section size of the inner transferring passage 14a, and for example, the section size of the cavitation passage 24 may become a nozzle shape with 60 to 85 μm diameter. The raw material solution flowing along the inner transferring passage 14a may be guided to the diffusing block 25 with the diffusing passage 25a. And then, the homogeneous solution made for the raw material solution may flow to the heat exchanger in a homogeneous solution state.

FIG. 5 shows an exemplary embodiment of a heat exchanger for the method according to the present invention.

Referring to FIG. 5, the heat exchanger 17 may comprise a housing 41; a heat exchanging tube 42 formed within the housing 41 and with a coil shape; an entering tube 43 for transferring the homogeneous solution to the heat exchanging tube 42; and a discharging tube 44 for discharging the homogeneous solution from the heat exchanging tube 42 to a storing tank for storing the homogeneous solution.

A coolant tube for guiding a coolant within the heat exchanger 17 may be arranged. The ultrasonic wave units 45a, 45b, 45c may be installed at various places of the housing 41. The ultrasonic wave units 45a, 45b, 45c may be installed at a round surface of the housing 41, may be installed at a cover of the housing 41, or may be installed at a lower surface of the housing. When the ultrasonic wave unit 45a is installed at the cover of the housing 41, an ultrasonic wave transferring member 451 may be coupled to the ultrasonic wave unit 45a for applying the ultrasonic wave to the homogenous solution flowing within the housing 41. When the ultrasonic wave unit 45c is placed under the housing 41, an ultrasonic wave transferring plate 411b may be installed under the housing 41. A plurality of vibrating elements may be placed at the transferring plate 411b, and the ultrasonic wave may be guided in a predetermined direction by the vibrating elements. The ultrasonic wave unit 45a, 45b, 45c may be arranged at various places of the heat exchanger 17 to apply the ultrasonic wave to the homogeneous solution flowing along the heat exchanging tube 42. And the ultrasonic wave unit 45a, 45b, 45c may have a proper structure to apply the ultrasonic wave to the homogeneous solution.

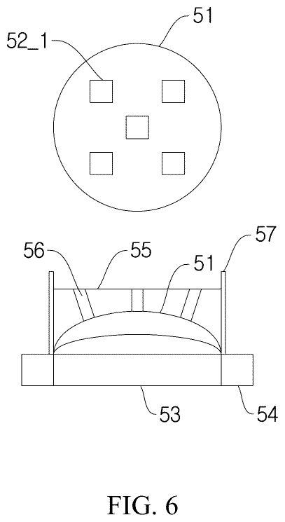

FIG. 6 shows an exemplary embodiment of an ultrasonic unit for the method according to the present invention.

Referring to FIG. 6, the ultrasonic wave unit may comprise a direction guiding unit 51 and a plurality of vibrating elements 52_1 to 52_N arranged at the direction guiding unit 51. And also, the ultrasonic wave unit may comprise a transferring unit 55 and a transfer limiting member 57 formed at a rounding surface of the transferring unit 55. And also, the ultrasonic unit may comprise a fixing unit 53, and the ultrasonic wave limiting unit 54 may be arranged at a rounding surface of the fixing unit 53. Each vibrating element 52_1 to 52_N may comprise a piezo-electric element, and may be made as a transducer to convert an electric vibration into a mechanical vibration. The direction guiding unit 51 may become an ultrasonic wave lens to guide the ultrasonic wave generated at the vibrating elements 52_1 to 52_N in a predetermined direction, the direction guiding unit 51 may have a concave shape or a convex shape. The transferring unit 55 may place the ultrasonic wave unit at the inputting container, at the transferring passage or at the inner part of the heat exchanger for transferring the ultrasonic wave generated at the vibrating elements 52_1 to 52_N in a predetermined direction through the ultrasonic wave transferring member 56. The ultrasonic wave unit may be coupled to the heat exchanger by the fixing unit 53. The ultrasonic wave limiting unit 54 may be arranged at the round surface of the fixing unit 53 for preventing the ultrasonic wave from being transferring to the housing 51 or any other route. The transfer limiting member 57 or the ultrasonic wave limiting unit 54 may be a porous material or a sound absorbing material capable of absorbing a sound or a vibration, and the ultrasonic transferring member 56 may be made of a metal material with a high density. The vibrating element for receiving a reflected ultrasonic wave may be arranged at the ultrasonic wave unit. The ultrasonic wave unit may transmit the ultrasonic wave to the homogenous solution for stabilizing, and it is advantageous that the ultrasonic wave has to be transmitted in a direction where the reflected ultrasonic wave is minimum, Therefore, the transmitting direction of the ultrasonic wave may be controlled according to a strength or a direction of the wave received by the receiving vibration element. The strength information of the reflected ultrasonic wave received by the receiving vibrating element may be transmitted to a controlling unit, and the controlling unit may control an applying direction of the ultrasonic wave unit according to the strength information of the reflected ultrasonic wave. The transmitting direction of the ultrasonic unit may be control in various ways, for example, the transmitting direction may be controlled by regulating a curvature of the direction guiding unit 51. The ultrasonic wave may be applied to the homogeneous solution in various ways.

A homogeneous mixture of the water and the oil was generated using the homogenizer discussed above,

### EXAMPLE

A water and an orange oil were stirred in a stirring device, and the water and the orange oil was prepared as the weight ratio is water:oil=85:15 to input into the homogenizer

B. 15,000 psi pressure was applied to the mixed solution in the homogenizer for generating the first homogenized solution. And an ultrasonic wave with a 20 kHz frequency was applied to the first homogenized solution in a condition of 15° C. temperature and a 1,400 W output for sonication.

C. The first homogenized solution treated with the ultrasonic wave was diluted as the water ratio is water:orange oil=95.5:0.5, and the second homogenizing and ultrasonic wave treating process was performed as the same condition as the first homogenizing and ultrasonic wave treating process. Thereby a homogeneous mixture of the water and the orange oil was made, and the final solution became 0.5% mixture of the water and the orange oil.

Result

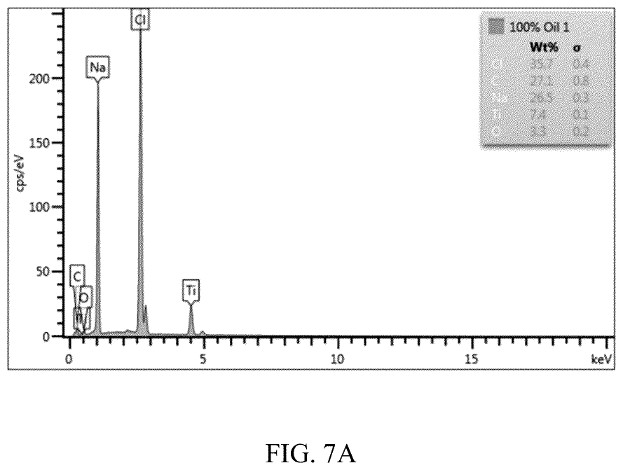

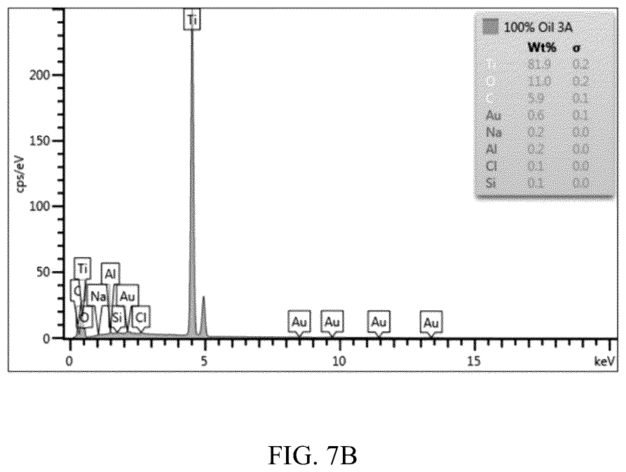

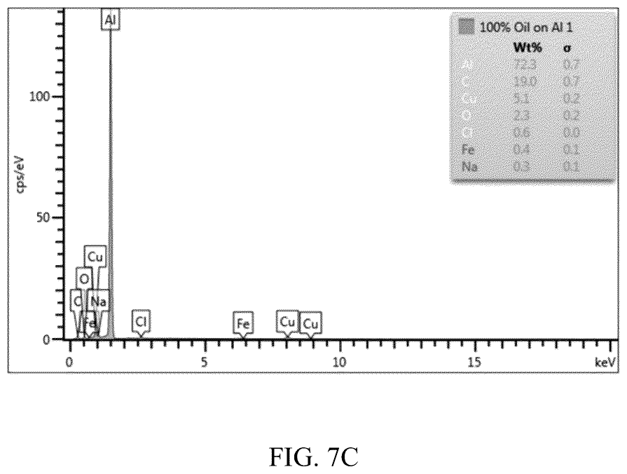

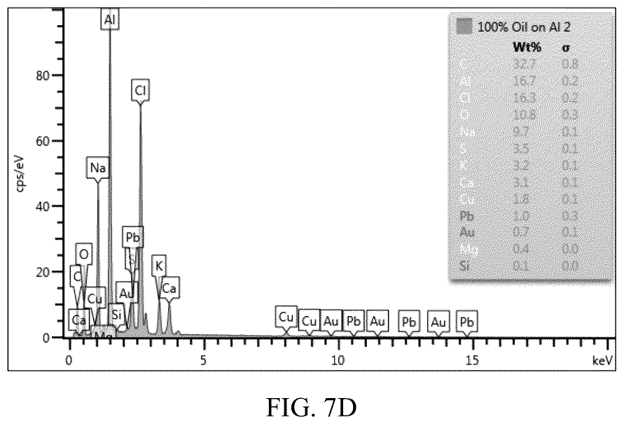

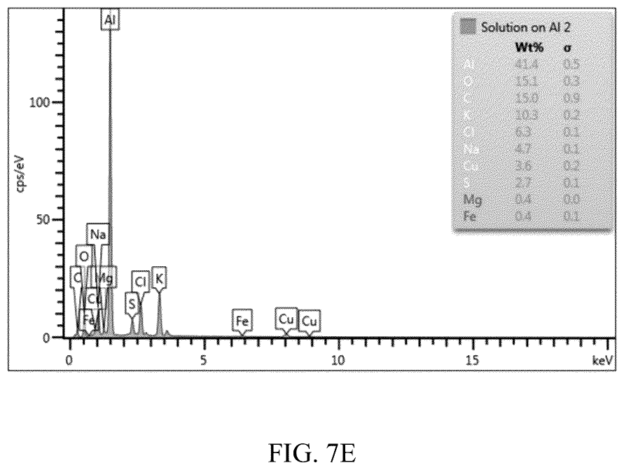

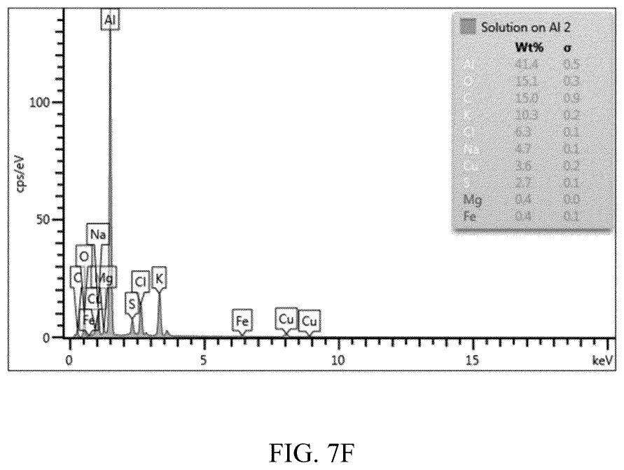

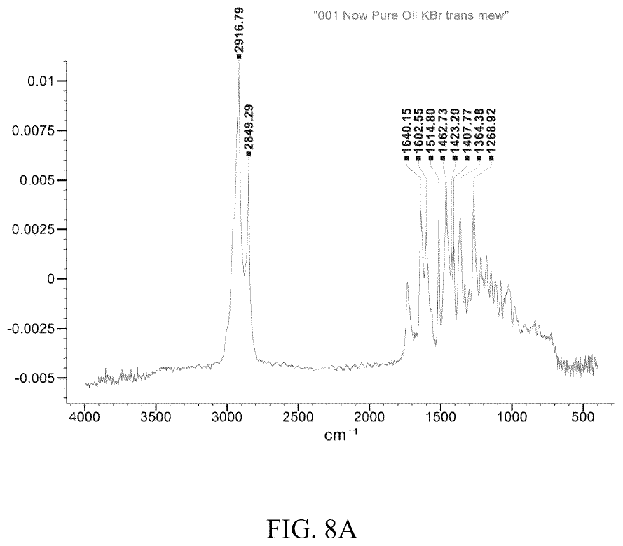

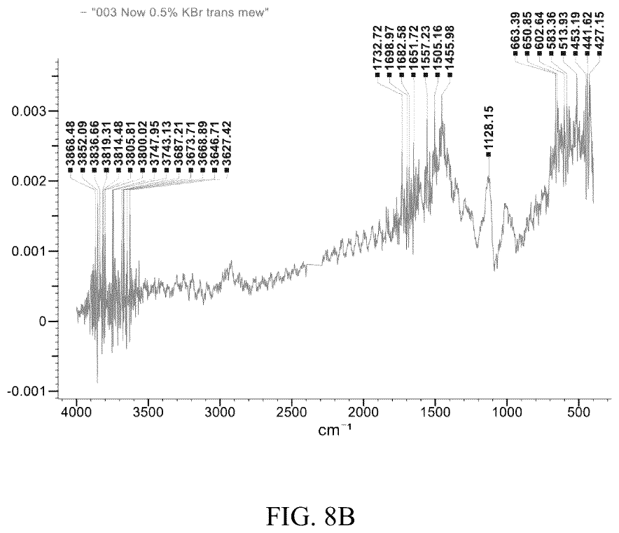

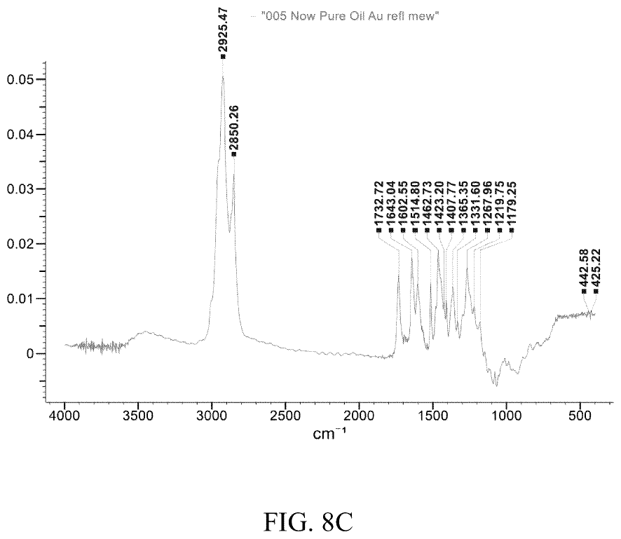

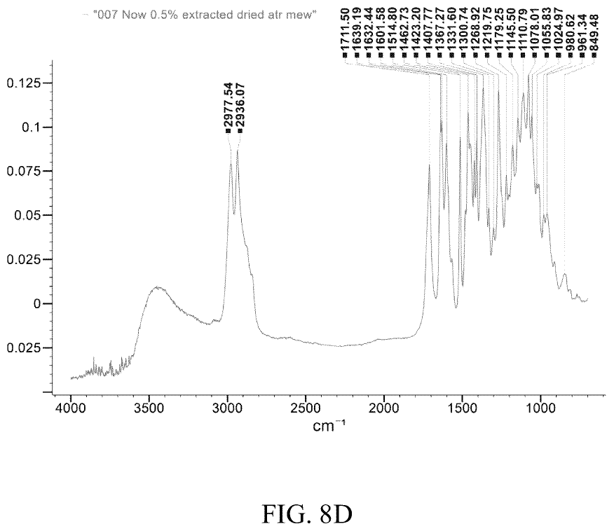

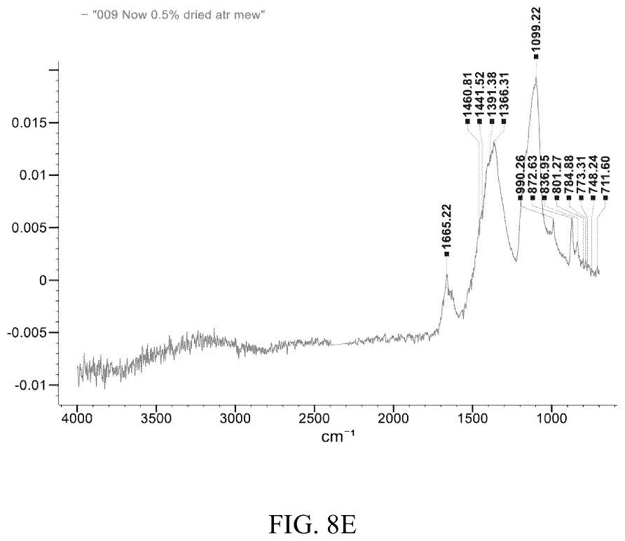

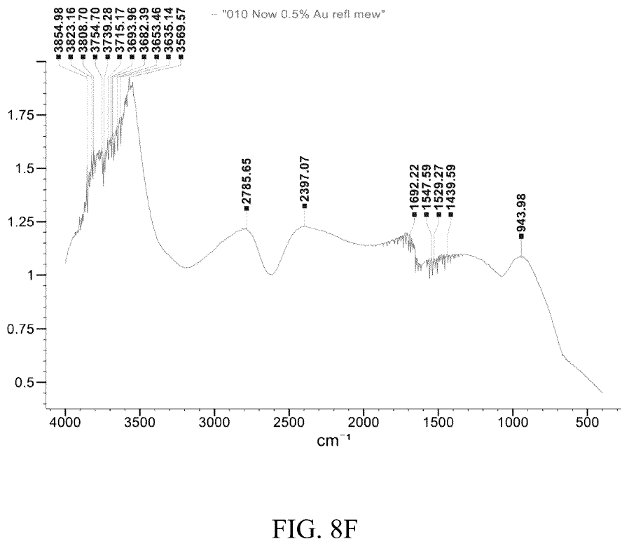

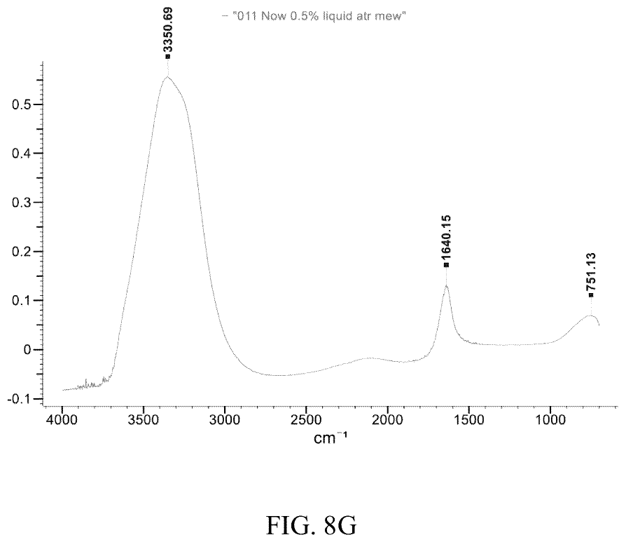

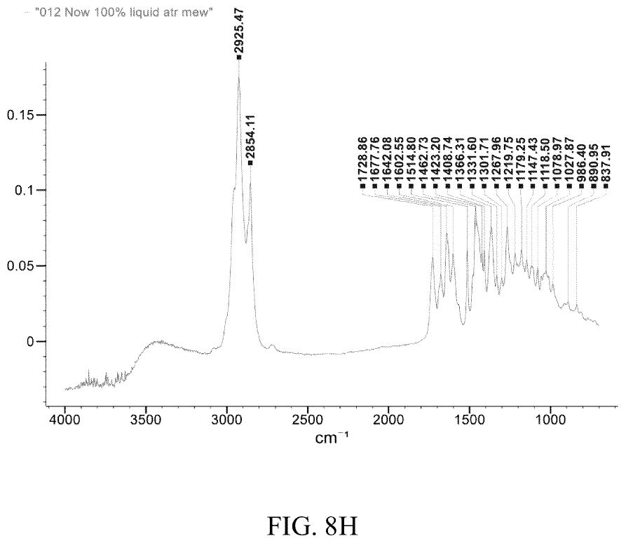

The homogeneous mixture of the water and the oil was tested according to EDS (Energy Dispersive Spectroscopy) and FTIR (Fourier Transform Infrared Spectroscopy) analysis. ASTM E 1252 was used for FTIR analysis, and the test was performed on an Agilent Cary 670 (with 620 IR microscopy) with an MCT single point detector coupled to an FTIT microscope with a germanium slide-on ATR crystal. The homogeneous was compared with a 100% oil for test, and the result was shown in FIG. 7A to 7F and FIG. 8A to FIG. 8H

FIG. 7A and FIG. 7B show representative EDS semi-quantitative analyses of the 100% oil sample on a titanium stub, and FIG. 7C and FIG. 7D show representative EDS semi-quantitative analyses of the 100% oil sample on an aluminum stub. FIG. 7E and FIG. 7F show representative EDS semi-quantitative chemical analyses of 0.5% homogeneous mixture of the water and oil according to the present invention on the titanium stub and the aluminum stub, respectively. As can be seen from FIG. 7A to FIG. 7F, the homogeneous mixture according to the present invention contain no component except the oil.

FIG. 8A and FIG. 8B show testing results of KBr salt plate transmission to 100% oil and the homogeneous mixture according to the present invention, and FIG. 8C and FIG. 8D show testing results of an Au plate reflectance and ATR (Attenuated Total Reflection) to the 100% oil and 0.5% homogeneous mixture according to the present invention. FIG. 8E and FIG. 8F c show testing results of dried ATR and Au-plate reflectance to 0.5% homogeneous mixture according to the present invention. And FIG. 8G and FIG. 8H show testing results of a liquid ATR to 0.5% homogeneous mixture of the present invention and 100% oil, respectively.

As seen from the testing result, the homogeneous mixture of the present invention contains no component except the oil component and the water component, and the homogeneous mixture contains only the oil component and the water mixed uniformly each other.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method for producing a homogeneous mixture, comprising:
stirring two liquid components being immiscible each other;
mixing and homogenizing the two liquid components as a first homogenizing stage in a high pressure;
applying an ultrasonic wave to the first homogenized two components as a first ultrasonic stage;
regulating a weight ratio of the homogeneous components;
homogenizing the regulated homogeneous components as a second homogenizing stage in a high pressure;
applying an ultrasonic wave to the second homogenized components as a second ultrasonic stage; and
generating a homogeneous mixture without any layer separation.

2. The method according to claim 1, wherein the two components are a water and an oil.

3. The method according to claim 2, wherein the water and the oil are mixed in a weight ratio of water:oil=80:10 to 30 in the first homogenizing stage, and in a weight ration of water:oil=100:0.1 to 10 in the regulating stage.

4. The method according to claim 1, wherein 10,000 to 30,000 psi pressure is applied in the first or second homogenizing stage.

5. The method according to claim 1, wherein the ultrasonic wave frequency is 20 kHz to 30 kHz frequency in the first or the second ultrasonic stage.

6. A homogeneous mixture of a water and an oil, wherein the weight ratio of the water and the oil is water:oil=100:0.1 to 5 and the mixture has no layer separation.
